(19) United States
(12) Patent Application Publication
(10) Pub. No.: US 2002/0108025 A1
(43) Pub. Date: Aug. 8, 2002

(54) MEMORY MANAGEMENT UNIT FOR JAVA ENVIRONMENT COMPUTERS

(76) Inventor: NICHOLAS SHAYLOR, NEWARK, CA (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 09/176,530

(22) Filed: Oct. 21, 1998

(51) Int. Cl. G06F 12/08

(52) U.S. Cl. 711/203; 711/165

(57) ABSTRACT

A method for managing memory in a computing system having a defined virtual address space and a physical memory. The virtual address space is partitioned into an upper portion and a lower portion. All of the physical memory is mapped to the lower portion of the virtual address space. A task comprising code static data, and heap data structures are executed by copying the code data structures of the task to the physical memory. A contiguous region of physical memory is allocated to the task's data structures. The contiguous region of physical memory is mapped into a segment of the upper portion of the virtual address space. The task's data structures can be expanded by mapping additional physical address space to the task's upper segment or by moving the entire data structures to a second contiguous region of physical memory.

### BACKGROUND OF THE INVENTION

1. Field of the Invention

The present invention relates, in general, to memory management, and, more particularly, to an apparatus and method for managing memory in a computer environment based on the JAVA programming language.

2. Relevant Background

The JAVA™ (a trademark of Sun Microsystems, Inc.) programming language, is an object-oriented programming language developed by Sun Microsystems, Inc., the Assignee of the present invention. The JAVA programming language and programming environment shows promise as a language for applications in comparatively simple computer environments such as that found in embedded systems, network computers, and the like. In these simpler environments the computer system hardware is desirably less complex to decrease cost. For example, it is desirable in some applications to provide hardware with only rudimentary memory management functionality. In these systems, the operating system (OS) and/or application software desirably provide the memory management functionality removed from the hardware.

The JAVA programming environment, among others, can be implemented using a “virtual machine” that runs on top of the operating system, yet implements an application program interface (API) that provides many behaviors traditionally associated with an operating system. The virtual machine enables the application developer to target the application software for a single machine via the virtual machine's API, yet expect the application software to operate on a wide variety of platforms that implement the virtual machine. It is desirable to have the program functionality provided with as little reliance on the underlying hardware and operating system implementation as possible so that the program can be readily ported to other platforms.

One area in which the hardware is traditionally heavily relied on is memory management. The term “memory management” refers to a set of functions that allocate memory as required to efficiently execute an application. Because the memory required by an application is dynamic, (i.e., an application may require more memory than was initially allocated) the memory management system must be able to dynamically allocate available physical memory address space in a manner that prevents one application from expanding into and corrupting the physical address space used by another application. Conventional memory management architectures handle this dynamic allocation by relying on the hardware memory management unit (MMU) to flush and re-populate physical memory with required data, however, such operation can greatly impact memory performance.

The design of memory storage is critical to the performance of modern computer systems. In general, memory management involves circuitry and control software that store the state of a computer and programs executing on the computer. The term “memory management” has three distinct meanings in the computer industry: hardware memory management, operating system memory management, and application memory management. Hardware memory management involves hardware devices usually implemented in or closely coupled to a CPU such as memory management units (MMUs), single in line memory modules (SIMMs), RAM, ROM, MMUs, caches, translation lookaside buffers (TLBs), backing store, and processor registers, refresh circuitry and the like. Operating system (OS) memory management handles behavior implemented in the operating system including virtual memory, paging, segmentation, protection and the like. Application memory management handles behavior implement by application software for memory area allocation, object management, garbage collection, and debugging.

Applications principally use two dynamic memory structures: a stack and a heap. A stack is a data structure that allows data objects to be pushed onto the stack and popped off it in the reverse order from which they were pushed. Memory requirements for the stacks in a particular application are typically known when an application is compiled. The “heap” refers to memory that is allocated at run-time from a memory manager, which can be of run-time-determined size and lifetime. The heap is used for dynamically allocated memory, which is usually for blocks whose size, quantity, or lifetime could not be determined at compile time. The reclamation of objects on the heap can be managed manually, as in C, or automatically, as in the Java programming environment.

In a conventional memory architecture the memory address space is divided into multiple pages. A particular program is assigned a number of pages of memory. When the program needs more memory, it can be allocated one or more additional pages. Because the pages allocated to a program do not have to be contiguous in physical memory, the program can be allocated additional memory so long as additional pages are available. Prior architectures rely heavily on the hardware MMU to handle this dynamic allocation of pages.

The memory management mechanisms operate in concert such that when data required by an application is not loaded in physical memory when demanded by the application, a “page fault” is generated which causes the operating system to “page in” the missing data. The hardware memory management mechanisms operate to determine the physical address of the missing data and load the data from slower memory or mass storage. In a cached memory system, the hardware memory management mechanisms attempt to keep the most likely to be used data in fast cache memory.

Paged virtual memory systems distinguish addresses used by programs (i.e., virtual addresses) from the real memory addresses (i.e., physical addresses). On every memory access the system translates a virtual address to a physical address. This indirection allows access to more memory than physically present, transparent relocation of program data, and protection between processes. A “page table” stores the virtual:physical address mapping information and a TLB caches recently used translations to accelerate the translation process.

A TLB comprises a number of entries where each entry holds a virtual:physical address mapping. The number of entries determines the maximum amount of address space that can be reached by the TLB. As programs become larger (i.e., require a larger amount of physical memory to hold the programs working set) and memory becomes less expensive, computer system manufacturers have increased the amount of physical memory available in computer systems. This trend places pressure on the TLB to map an increasingly larger amount of memory. When a required mapping is not in the TLB (i.e., a TLB miss), a TLB miss handler causes the retrieves the required mapping from the page table. Programs incur a large number of TLB misses when their working set is larger than the TLB's reach. TLB miss handling typically requires multiple clock cycles and greatly impacts memory performance.

TLB performance is improved by increasing the number of entries in the TLB. However, fast memory cells required by a TLB consume a relatively large amount of chip area and available chip power. Also, large virtual and physical addresses (e.g., 64-bit addresses) increase the number of bits in each TLB entry, compounding the difficulty in adding more entries to the TLB. Moreover, as the TLB size increases, the access speed tends to decrease thereby lowering overall memory access speed.

A need exists for a memory architecture that avoids many of the design and performance limiting features of conventional memory management units. It is desirable to satisfy this need with a memory architecture that satisfies the dynamic memory requirements of programs with graceful performance degradation when memory is full.

### SUMMARY OF THE INVENTION

Briefly stated, the present invention involves a memory architecture, as well as a method, system and computer program product for maintaining a memory architecture, that treats physical memory as a single segment rather than multiple pages. A virtual memory address space is divided into two regions with a lower region being mapped directly to physical memory and each location of the physical memory being mapped to an aliased virtual address in the upper section.

A method for managing memory in a computing system having a defined virtual address space and a physical memory. The virtual address space is partitioned into an upper portion and a lower portion. All of the physical memory is mapped to the lower half of the virtual address space. A task comprising code, static data, and heap structures is executed by copying all these data structures to a contiguous region of the physical memory. This region is mapped into a single segment that is mapped to the upper portion of the virtual address space. The segment can be expanded by mapping additional physical address space or by moving the entire task structure to a larger contiguous region of physical memory.

The foregoing and other features, utilities and advantages of the invention will be apparent from the following more particular description of a preferred embodiment of the invention as illustrated in the accompanying drawings.

### BRIEF DESCRIPTION OF THE DRAWINGS

FIG. 1 shows in block diagram form a computer system embodying the apparatus, methods and devices in accordance with the present invention;

FIG. 2 shows a memory subsystem in accordance with the present invention in block diagram form;

FIG. 3 illustrates a memory mapping in accordance with the present invention;

FIG. 4 shows a first example of dynamic memory allocation in accordance with the present invention;

FIG. 5 illustrates a second example of dynamic memory allocation in accordance with the present invention;

FIG. 6 shows in simplified block diagram form significant components of a memory management device in accordance with the present invention; and

FIG. 7 illustrates a third example of dynamic memory allocation in accordance with the present invention.

### DETAILED DESCRIPTION OF THE PREFERRED EMBODIMENTS

The present invention is directed to memory management mechanisms and methods that can be readily implemented in a virtual machine, such as a JAVA virtual machine (JVM), to provide benefits of virtual memory management without reliance memory management hardware to provide paging mechanisms. VMs have traditionally relied on the MMU hardware, to provide the benefits of paged virtual memory. By implementing the method and apparatus in accordance with the present invention, a simplified version of virtual memory management can be built into the VM thereby making the VM more portable and able to operate on platforms that do not provide virtual memory management.

To ease description and understanding the present invention is described in terms of a specific implementation having a 32-bit virtual address space defining 4 Gigabytes (GB) of virtual memory. The virtual address space is divided into two equally sized regions each having 2 GB of the virtual address space. A lower 2 GB region corresponds directly with physical memory 203 while an upper 2 GB region comprises virtual memory that can be mapped to any arbitrary location in the lower 2 GB region. While the amount of physical memory varies from computer to computer, it is typically no more than a few tens or perhaps a few hundred megabytes (MB). Regardless of the amount of physical memory, all of that physical memory is mapped directly to the lower address region.

The present invention is preferably implemented in a virtual machine operating on an arbitrary hardware/OS platform. In accordance with the present invention, the virtual machine relies minimally on the platform to perform memory management. Instead, the advantages of conventional paging systems are implemented by the task swapping method and mechanisms of the present invention described hereinbelow.

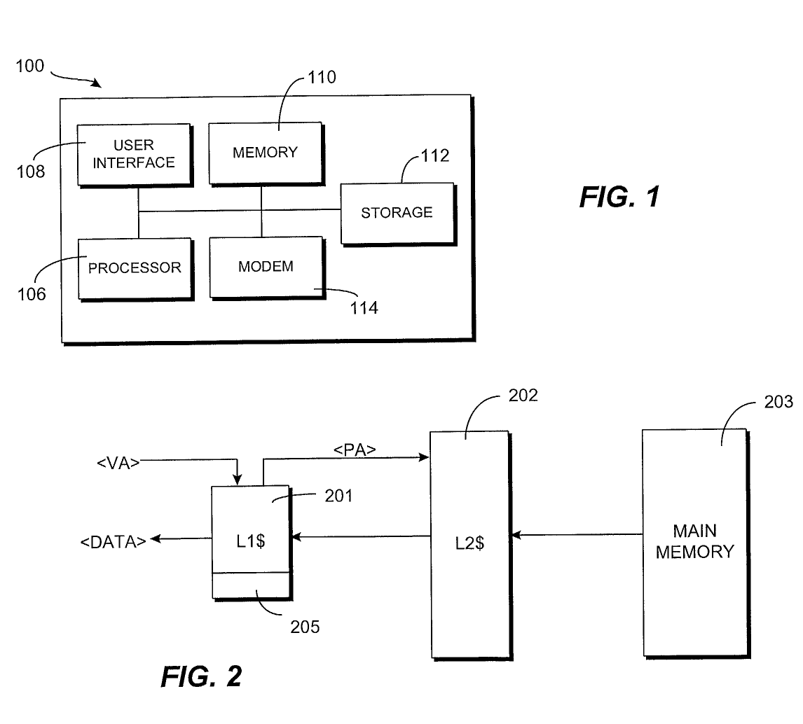

FIG. 1 illustrates a computer system 100 configured to implement the method and apparatus in accordance with the present invention. The computer system 100 has a processing unit 106 for executing program instructions that is coupled through a system bus to a user interface 108. User interface 108 includes available devices to display information to a user (e.g., a CRT or LCD display) as well as devices to accept information form the user (e.g., a keyboard, mouse, and the like).

A memory unit 110 (e.g., RAM, ROM, PROM and the like) stores data and instructions for program execution. As embodied in computer code, the present invention resides in memory unit 110 and storage unit 112. Moreover, the processes and methods in accordance with the present invention operate principally on memory unit 110. Storage unit 112 comprises mass storage devices (e.g., hard disks, CDROM, network drives and the like). Modem 114 converts data from the system bus to and from a format suitable for transmission across a network (not shown). Modem 114 is equivalently substituted by a network adapter or other purely digital or mixed analog-digital adapter for a communications network.

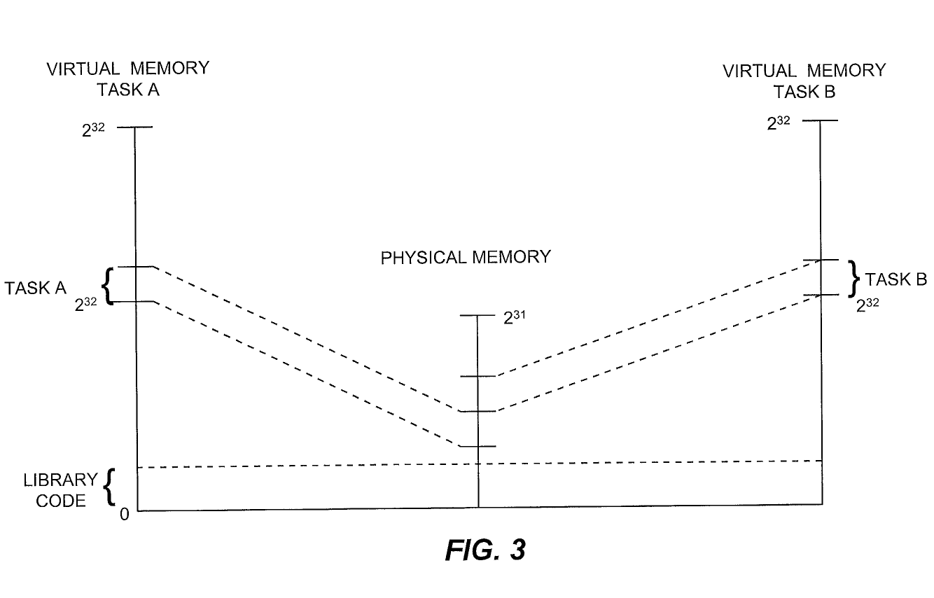

FIG. 2 illustrates a portion of memory unit 110 in greater detail. Memory unit 110 implements physical or real memory having a size or capacity determined by the physical size of main memory 203. Preferably, memory unit 110 comprises cached memory such that dynamically selected portions of the contents of main memory 203 are copied to one or more levels of smaller, faster cache memory such as level one cache (L1$) 201 and level 2 cache (L1$) 202. Any available cache architecture and operating methodology may be used except as detailed below.

In the particular example of FIG. 2, L1$ 201 is virtually addressed while L2$ 202 (if used) and main memory 203 are physically addressed. Virtual addresses generated by a program executing on processor 106 (shown in FIG. 1) are coupled directly to the address port of L1$ 201. When L1$ 201 contains valid data in a cache line corresponding to the applied virtual address, data is returned to processor 106 via a memory data bus. It should be understood that any number of cache levels may be used, including only one cache level (i.e., L1$ 201) as well as three or more cache levels.

The preferred implementation of L1$ 201 as a virtually addressed cache minimizes the address translation overhead needed to access data from the level one cache. While a physically addressed cache requires some form of relocation mechanism before it can be accessed, a virtually addressed L1$ only requires address translation where there is a miss in L1$ 201 will the virtual address need to be translated. L1$ 201 includes a number of cache lines 205 that are organized so as to hold both the corresponding virtual and physical addresses. This feature allows the L1$ 201 to snoop accesses to physical memory by CPU or direct memory access (DMA) in order to invalidate or modify cached memory when data is changed. As described below, virtual address translation register 205 is much smaller in capacity than conventional TLB structures because only a single virtual:physical address mapping needs to be held.

L1$ is sized appropriately so that typical program execution results in a desirably high cache hit rate. The characterization of caches and cache hit rate with cache size is well known, and the particular cache size chosen to implement the present invention is a matter of design choice and not a limitation of the invention. Larger caches can lead to better cache performance and so are recommended.

At any one time, L1$ 201 will hold a range of virtual addresses referred to as the “current virtual address space”. In a particular example, it is assumed that desired data is currently in L1$ 201 so that data is accessed in an unchecked manner. Cache consistency is maintained in software executing in processor 106 (e.g., a Java virtual machine). Accesses to memory locations outside of the current virtual address space raise a trap in the virtual machine at the time the address translation is performed. This is an error condition that the virtual machine responds by aborting the program. Preferably, L1$ 201 is organized such that each cache line includes state information to indicate, for example, whether the cache line is valid. This feature allows L1$ 201 to snoop accesses to physical memory by CPU or DMA access in order to invalidate or modify cache memory when it is changed.

FIG. 3 graphically illustrates a virtual:physical address mapping in accordance with the present invention. As shown in FIG. 3, portions of a 32-bit virtual address space are allocated to a task A and a task B. Each task address space is mapped to a corresponding segment of the physical memory. The maximum physical memory capacity is one half that of the virtual address space as a result of allocating the upper half of the virtual address space for aliased mappings. In the particular example of FIG. 3, the lowest segment of physical address space is reserved for “library code” that is referred to by all executing programs including the virtual machine, and must be present for the virtual machine to operate. Above the library code segment the available physical memory can be allocated as desired to tasks. As shown, task A is allocated to a first segment above the library segment and task B is allocated to a task address space immediately above task A. The specific mapping of task A and task B is handled by the memory manager component in accordance with the present invention and implemented in a virtual machine in the particular example.

Significantly, physical memory in FIG. 3 is not paged. Task A and task B can be swapped out of physical memory as required and held in virtual memory by maintaining the virtual address allocation. Task A and/or task B can be moved within physical memory by changing the memory mapping (designated by dashed lines in FIG. 3). However, task A and task B are swapped or moved in their entirety and not on a page-by-page basis as in conventional memory management systems.

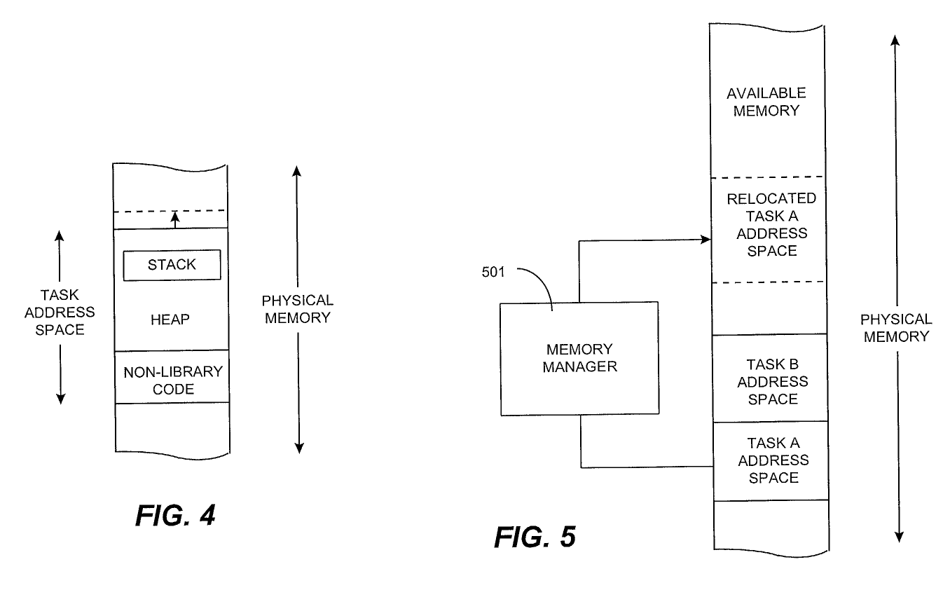

A typical application includes data structures shown in FIG. 4 including a heap data structure, a code data structure, and a stack data structure. All of these data structures must be present in physical memory for the task to execute. The present invention distinguishes between procedural code (e.g., C-language programs) and object-oriented code (e.g., JAVA language programs). For object-oriented code, most of the code is present in physical memory space library (labeled CODE in FIG. 4) and is addressed there directly. A task's non-library code, static data, and single heap component is allocated from addresses in physical memory space, but is also mapped into aliased virtual memory addresses in the upper portion of the virtual address space as shown in FIG. 3.

The heap component can dynamically change size while a task is executing. The task will request additional memory space for the heap and the memory manager in accordance with the present invention attempts to allocate the requested memory address space. In the event that the heap component needs to be expanded two conditions may exist. First, the physical address space immediately adjacent to the heap (e.g., immediately above task A or task B in FIG. 3) may be available in which case the heap component is simply expanded into the available address space as shown in FIG. 4. In this case, the memory mapping is altered to include the newly added physical memory addresses in the portion of physical memory allocated to the heap data structure.

In a second case, illustrated in FIG. 5, the address space immediately above the heap of task A is not available because it is occupied by task B. In this case, the entire segment is copied to another area of physical memory that is large enough to hold the expanded size. Memory manager 501 determines if a suitably sized segment of available memory exists, then copies all of the task A data structure in its entirety to the address space designated in FIG. 5 as the relocated task address space. In the second case, the virtual address mapping represented by the dashed arrows in FIG. 3 is altered to reflect the new heap location.

The main memory could require compacting for this to occur (i.e., in order to free a sufficiently large address space to hold the increased heap size), however, this should not be frequent and so is not expected to effect performance in a significant way. Compacting uses small amounts of unallocated physical address space that may exist. For example, the address space between task A and the library code segment in FIG. 3 can be used by moving task A downward to occupy memory immediately above the library code segment.

In accordance with the present invention, the virtual machine allocates the stack regions for object oriented tasks such as Java tasks from within the heap as shown in FIG. 4. In a preferred implementation, a stack pointer (not shown) is associated with the stack memory area. Associated with the stack pointer is a stack limit register (not shown) that is used to indicate (e.g., raise a trap) if more data is pushed onto the stack than can be accommodated by the current address space allocated to the stack. Stack area may also increase in size, for example, during iterative processes that create stack data structures each iteration. In accordance with the present invention, stack areas used for Java language threads can either be expanded when necessary by relocating the stack within the heap, or by implementing a “chunky” stack mechanism. This stack allocation system has the important quality of allowing several stacks to be created within one program.

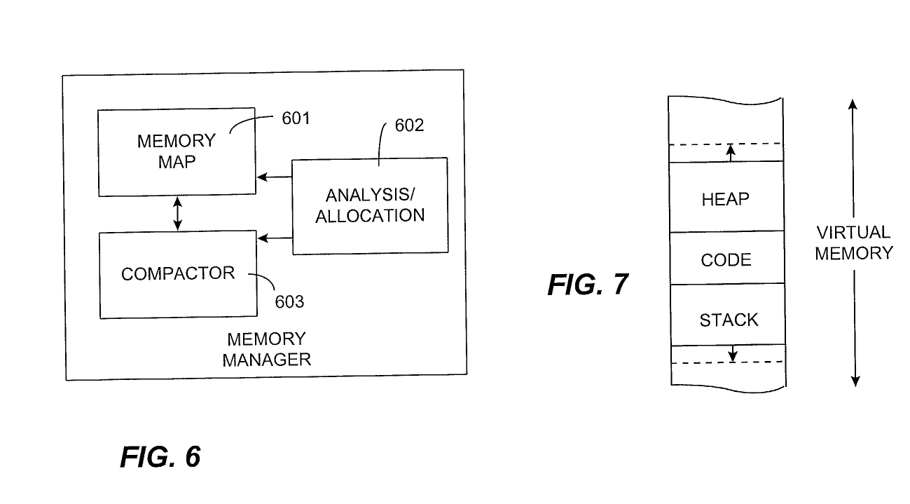

FIG. 6 shows basic devices, implemented as software code devices in a particular example, that handle memory management operations within memory manager 501. It should be understood that a typical memory manager 501 will include a number of other modules to provide conventional memory management operation, but for ease of understanding these conventional devices are not illustrated or described herein. Memory map 601 is a data structure that tracks which memory regions are assigned to which tasks and which physical memory is available for allocation. Analysis/allocation device 602 can monitor memory map 601 to determine if physical memory is available above a task's allocated address space for purposes of expanding/reallocating the task's heap address space. Analysis/allocation device 602 can also initiate compactor 603 to defragment physical memory as needed.

To ensure execution integrity, an executing task cannot write to memory address space that is allocated to another process. While a Java language task is executing it will normally (although not exclusively) use virtual addresses internally to refer to data objects in the stack and heap areas associated with that task. A task may invoke operating system resources in which case the OS typically uses real addresses. When the operating system API is called, all virtual addresses are translated into real addresses that are used throughout the operating system code. Virtual-to-physical translation is done only once very early on in processing. In this manner, virtual addresses are only used by the task whose context they belong in and execution integrity is ensured. In other words, a set of virtual addresses used by a given task will not, except as detailed below, refer to data locations that it does not own and so will not corrupt memory locations allocated to other tasks.

Occasionally, a task may use physical addresses to refer to data objects that were created outside of the task itself. For example, during I/O processing a first task, or driver may bring data in from, for example, a network connection, and store that data in a buffer created in physical memory. A second task will read the data from the buffer location directly and use the data. It is a useful optimization for the second task to refer to the physical address of the buffer location established by the first task to avoid copying the data from one task address space to another.

Allowing tasks to use real addresses in this manner works well in most of the JAVA language java.io classes. However, the software memory manager must be trusted to not allow a task to use physical addressing in a manner that would breach execution integrity. These tasks are referred to herein as “trusted tasks”. A virtual machine in accordance with the present invention will be considered a trusted program. To handle untrusted tasks, the lower 2 GB region (i.e., the real-address space) can be placed in read only mode while the untrusted task is executing.

Another useful implementation of the present invention groups tasks, where possible, into virtual address space groups. A virtual address group is sized so that all the tasks in the group are cacheable, together, at any given time in L1$ 201. This feature requires that such tasks can be relocated at load time. Using this implementation, so long as context switches occur only between tasks within a single virtual address group, L1$ 201 does not need to be flushed. L1$ 201 will need to be flushed whenever a group-to-group context switch occurs. The memory manager in accordance with the present invention can further improve performance by recording how much heap space each task normally requires and use this information when the tasks are subsequently executed. The operating system can use this historical information to allocate memory to the task such that compatibility within a virtual address space group is more optimal.

On the odd occasion where a task exceeds its allotted virtual address space (e.g., the stack area and/or heap area expands unexpectedly) the task is removed to its own separate virtual address space group. All virtual addresses must be flushed from L1$ 201 when a context switch occurs that involves two separate virtual address space groups, but this is expected to be a rare occurrence in many practical environments running a stable set of tasks.

So long as all the tasks in a virtual address space group are selected to have compatible virtual address requirements, L1$ 201 accesses can be performed in an unchecked manner (i.e., no special effort need be made to ensure that a virtual address does not refer to an out of context memory location). However, a program bug could cause an access to be an out of context access, which would not normally be valid. Trusted programs, such as the Java VM, can be relied on to not generate any such accesses. However, procedure or native code programs such as C-language programs are not trusted and so should be forced into separate address space groups to avoid them breaching execution integrity.

The examples of FIG. 4 and FIG. 5 deal with Java language or similar programming language in which the stack data structures are allocated from within the heap data structure. FIG. 7 shows how a C-language task can be organized in such a way that all the code and data structures are mapped into virtual address. The task's data structures are allocated in the middle of the high virtual address space so that the stack can be expanded downward and the heap can be expanded upward if need be.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method for operating a memory in a computing system having a defined virtual address space, the computing system including a physical memory, the method comprising the steps of:
partitioning the virtual address space into an upper portion and a lower portion;
mapping all of the physical memory to the lower portion of the virtual address space;
initiating execution of a first task, the first task comprising code, static data, and heap data structures;
in response to initiating execution:
copying the code data structures of the first task to the physical memory;
allocating a contiguous region of physical memory to the first task's data structures; and
mapping the allocated contiguous region of physical memory into a segment in the upper portion of the virtual address space.

2. The method of claim 1 wherein the allocating is performed so that the contiguous region is sized to hold all of the first program's data structures.

3. The method of claim 1 further comprising:
in response to the first task requesting an extension to its heap data structure that is larger than its current contiguous region, determining whether the physical memory immediately adjacent to the allocated region is available; and
allocating the immediately adjacent physical memory to the first program's heap data structure when the immediately adjacent address space is available.

4. The method of claim 1 further comprising:
in response to the first task requesting a heap data structure that is larger than the first contiguous region, determining whether the physical memory immediately adjacent to the allocated region is available; and
when the immediately adjacent address space is not available:
allocating a second contiguous region of physical memory to the task; and
moving all of the task's data structures to the second contiguous region of physical memory.

5. The method of claim 4 further comprising the step of compacting the physical memory to create sufficient contiguous free space in the physical memory in which to allocate the second contiguous region.

6. The method of claim 4 wherein allocating the second contiguous region is performed so that the second contiguous region is sized to hold all of the first task's requested larger heap data structure.

7. The method of claim 1 wherein the first task further comprises at least one stack data structure having a preselected capacity, and the method further comprises:
allocating from within the heap data structure an area for holding the at least one stack data structure;
pushing data onto the at least on stack data structure;
determining if data pushed onto the at least one stack data structure exceeds it's capacity;
relocating the at least one stack data structure within the heap data structure; and
expanding the relocated stack data structure to have a capacity sufficient to hold the data being pushed.

8. The method of claim 1 wherein the first task further comprises at least one stack data structure having a preselected capacity, and the method further comprises:
allocating from within the heap data structure an first area for holding the at least one stack data structure;
pushing data onto the at least on stack data structure;
determining if data pushed onto the at least one stack data structure exceeds it's capacity; and
allocating from within the heap data structure an second area for holding a portion of the stack data structure that exceeds the capacity of the first allocated area.

9. The method of claim 7 wherein the step of relocating further comprises:
identifying an area within the heap data structure having sufficient free area to accommodate the expanded stack data structure.

10. The method of claim 7 wherein the step of relocating further comprises:
requesting a heap data structure that is larger than the first contiguous region so that the requested heap data structure size includes sufficient free area to accommodate the expanded stack data structure.

11. The method of claim 1 further comprising:
prior to the execution of the first program, determining from records of prior executions of the first task a historical target size of the heap data structure; and
performing the allocating step so that the first contiguous region is at least as large as the historical target size.

12. The method of claim 1 further comprising:
initiating execution of a second task, the second task comprising code, static data, and a heap data structures;
in response to initiating execution of the second task:
copying the code, static data and heap data structures of the second task to the physical memory;
mapping the contiguous region of physical memory into a segment of the upper portion of the virtual address space.

13. A memory manager comprising:
a virtual address space partitioned into an upper portion and a lower portion;
a plurality of tasks each comprising code, static data and heap data structures, each task structure occupying an area of virtual address space;
a physical memory comprising a plurality of locations, wherein the physical memory is partitioned as at least one atomic segment having a size determined by the heap data structure of one of the plurality of tasks;
a memory map mapping each segment of the physical memory directly to the upper portion of the virtual address space and to an aliased location in the lower portion of the virtual address space.

14. The memory manager of claim 13 wherein each segment of physical memory is sized such that the heap data structure of one of the tasks is implemented in segment of contiguous locations in the physical memory.

15. The memory manager of claim 13 wherein tasks are able to request additional virtual address space for the task's heap data structure and the manager further comprises:
an analysis device operative to determine if an amount of physical address space sufficient to satisfy the task request and immediately adjacent to the physical memory segment mapped to the task's heap data structure is available;
an allocating device responsive to the detecting device and operative to alter the memory map to increase the size of the atomic segment such that the task's heap data structure is sized to satisfy the task request.

16. The memory manager of claim 13 wherein tasks are able to request additional virtual address space for the task's heap data structure and the manager further comprises:
an analysis device operative to determine if an amount of physical address space sufficient to satisfy the task request and immediately adjacent to the physical memory segment mapped to the task's heap data structure is available;
an allocating device responsive to the detecting device and operative to map a second contiguous region of physical memory to the program's heap data structure; and
a copying device responsive to the allocating device and operative to the program's heap data structure in its entirety to the second contiguous region of physical memory.

17. The memory manager of claim 16 further comprising a compacting device operatively coupled to the physical memory and to the memory map to defragment the physical memory.

18. The memory manager of claim 16 wherein the second contiguous region is sized to hold all of the task's requested larger heap data structure.

19. The memory manager of claim 13 wherein the physical memory comprises a physically addressed main memory and a virtually addressed main memory cache.

20. A computer system comprising:
a data processor;
a main memory coupled to the processor comprising a plurality of physically addressed memory locations;
a task loaded in the main memory comprising a code data structure and a heap data structure;
a memory management device coupled to the memory to selectively relocate the stack's heap data structures within the main memory by relocating the entire data structures as a unit from a first physical address space to a second virtual address space without paging.

21. A computer data signal embodied in a carrier wave coupled to a computer for managing memory in the computer, the computer data signal comprising:
a first code portion comprising code configured to cause the computer to partition the virtual address space into an upper half and a lower half;
a second code portion comprising code configured to cause the computer to map all of the physical memory to the lower half of the virtual address space;
a third code portion comprising code configured to cause the computer to initiate execution of a first task, the first task comprising a code data structure, and a heap data structure;
a fourth code portion response to the third code portion comprising code configured to cause the computer to copy the code data structures of the first task to the physical memory;
a fifth code portion comprising code configured to cause the computer to allocating a first contiguous region of physical memory to the first program's heap data structure; and
a sixth code portion comprising code configured to cause the computer to map the first contiguous region of physical memory into a segment of the upper half of the virtual address space.
